(19) United States
(12) Patent Application Publication
(10) Pub. No.: US 2009/0285248 A1
(43) Pub. Date: Nov. 19, 2009

(54) UV LIGHT GENERATION BY FREQUENCY CONVERSION OF RADIATION OF A RUBY LASER PUMPED WITH A SECOND HARMONIC OF A SOLID-STATE LASER

(75) Inventor: Fedor V. KARPUSHKO, Dortmund (DE)

Correspondence Address: SENNIGER POWERS LLP, 100 NORTH BROADWAY, 17TH FLOOR, ST LOUIS, MO, 63102, US

(73) Assignee: Klashtech-Karpushko Laser Technologies GmbH

(21) Appl. No.: 12/119,853

(22) Filed: May 13, 2008

(51) Int. Cl. H01S 3/109; H01S 3/082; H01S 3/11

(52) U.S. Cl. 372/10; 372/97; 372/22

(57) ABSTRACT

A system and method for generating ultraviolet laser radiation by pumping a ruby based active laser medium in a second complex laser cavity with an output from a first complex laser cavity. The laser system includes a first complex optical cavity a second complex optical cavity, an output from the first complex optical cavity at a second harmonic of the first fundamental frequency pumps a ruby based active medium of the second complex optical cavity. In some embodiments, the ruby based active medium can be Cr:Al₂O₃ type ruby.

### BACKGROUND

Ultraviolet laser radiation in the spectrum range around 350 nm has been used in industrial, scientific and particularly, medical and biotechnology areas. Such ultraviolet laser emission can be obtained by non-linear frequency conversion, for instance, by third harmonic generation (THG), of the radiation from Neodymium-doped laser crystals. In this case, at the first step of frequency conversion, a laser beam at a fundamental frequency is frequency doubled (second harmonic generation—SHG) in a first non-linear crystal. Then, at the second step, the resulting beam at the second harmonic of the fundamental frequency and the residual laser beam at the fundamental frequency are combined in the second non-linear crystal to produce a laser beam at the third harmonic of the fundamental frequency.

FIG. 1 illustrates a laser system for third harmonic generation (THG) In a laser resonator cavity 10 formed by a plurality of mirrors (20, 31, 32, 36), an active medium 21 is pumped by a pump source 34. In such a layout, the four mirrors (20, 31, 32, 36) are made highly reflective at the laser fundamental frequency (ω). The laser beam generated in the laser resonator cavity 10 at the fundamental frequency (ω) undergoes frequency doubling in a first non-linear crystal 30 to produce laser radiation at the second harmonic frequency (2ω). The laser beam at the fundamental frequency (ω) and the laser beam at the second harmonic frequency (2ω) interact under a special phase-matching condition in a second nonlinear crystal 50 to produce a laser beam at the third harmonic frequency (3ω). The laser beam at the third harmonic frequency (3ω) is transmitted through mirror 32 as the laser system output 52 at the third harmonic frequency (3ω). For a neodymium-doped active media 21, the wavelength corresponding to the fundamental frequency ω is in a range from about 1.053 μm to about 1.075 μm. The wavelength corresponding to the third harmonic frequency (3ω) is in the range of about 351 nm to about 357 nm.

In this scheme, the only useful loss of the laser beam at the fundamental frequency (ω) is by non-linear conversion into the second harmonic frequency (2ω) and the third harmonic frequency (3ω). Usually this loss is less than about 1% per cavity round-trip in the case of continuous wave (CW) lasers of small or moderate powers (in the range of milliwatts to a few watts). As a result, the total cavity loss is dominated by a internal part of the laser cavity, therefore making the overall laser efficiency (the third harmonic output with respect to the pump power) rather small.

Because of different phase-matching conditions inside non-linear crystals for second harmonic and third harmonic generation processes inside the same laser cavity imply contradictive technical realization of phase-matching leading for additional cavity losses, the frequency conversion efficiency at the stage of THG is much lower than that of at the stage of SHG, resulting in the low overall system efficiency (third harmonic output with respect to the pump power applied to the laser), usually far below 10%.

Another disadvantage of the above arrangement for producing UV light at around 350 nm by third harmonic generation of laser radiation is a high sensitivity of the laser output to small environmental changes, thermal effects, scattering by air, and the like. As the cavity loss is kept at a small value, small external disturbances can noticeably change the balance between the useful and internal loss of the laser cavity, leading to a strong variation of the laser output. This decreases the laser stability and necessitates stabilization measures and tight tolerances in the laser components used

Still another disadvantage is limited tunability of the third harmonic of a neodymium-based laser system below 351 nm. A laser beam at a wavelength below 351 nm is required for some biological applications, for instance, for minimizing an assay volume in test/diagnostics processes by fluorescence methods that implement, for example, Eu³⁺ in trisbipyidine as immunoassay for analytical solution

### SUMMARY OF THE INVENTION

A system and method are provided for generating ultraviolet laser radiation by pumping a ruby based active laser medium in a second complex laser cavity with an output from a first complex laser cavity. The laser system includes a first complex optical cavity, having a first cavity part of a lower level circulating first fundamental frequency power of the first complex optical cavity and a second cavity part of higher level circulating first fundamental frequency power of the first complex optical cavity, a neodymium-doped active medium in the first cavity part of the first complex optical cavity, at least one first non-linear crystal in the second cavity part of the first complex optical cavity; a second complex optical cavity, having a first cavity part of a lower level circulating second fundamental frequency power of the second complex optical cavity and a second cavity part of higher level circulating second fundamental frequency power of the second complex optical cavity, a ruby based active medium in the first cavity part of the second complex optical cavity, at least one second non-linear crystal in the second cavity part of the second complex optical cavity; and an output from the first complex optical cavity at a second harmonic of the first fundamental frequency pumps the ruby based active medium of the second complex optical cavity. In some embodiments, the ruby based active medium can be Cr:Al₂O₃ type ruby.

In some embodiments, an output of the second complex optical cavity can be configured to be at the second harmonic of the second fundamental frequency. The output of the second complex optical cavity can be about 350 nm.

In some embodiments, the first cavity part of the first complex optical cavity can include a cavity loss modulator for Q-switching. In some embodiments, the first cavity part of the second complex optical cavity can further include a cavity loss modulator for Q-switching.

In some embodiments, the first cavity part of the first complex optical cavity can include at least one spectral selector for narrowing the emission spectrum at the first fundamental frequency. In some embodiments, the first cavity part of the second complex optical cavity can further include at least one spectral selector for narrowing the emission spectrum at the second fundamental frequency.

In some embodiments, the neodymium-doped active medium of the first complex optical cavity can be pumped by a diode laser or a fiber coupled diode laser. In some embodiments, the neodymium-doped active medium can be neodymium-doped yttrium vanadate (Nd:YVO₄), neodymium-doped yttrium aluminum garnet (Nd:YAG), or neodymium-doped yttrium lithium fluoride (Nd:YLF),

In some embodiments, the second part of the first complex cavity can comprise a first non-linear resonant reflector at the first fundamental frequency incorporating the at least one first non-linear crystal. The backward reflectivity of the first non-linear resonant reflector, with respect to radiation incident upon it from the first cavity part of the first complex cavity, can be self-regulated by the presence of the at least one first non-linear crystal to be as close to the optimal value for out-coupling the circulating intracavity power at a first fundamental frequency within the first cavity part. In some embodiments, a first temperature control device can be used for controlling the temperature of the at least one first non-linear crystal of the first non-linear resonant reflector for tuning and stabilizing a phase-matching condition for frequency conversion. In some embodiments, a first piezo-electical transducer (PZT) with an appropriate controlling electronics can be used for fine tuning and stabilizing the optical path of the first non-linear resonant reflector at resonance conditions,

In some embodiments, the second part of the second complex cavity can comprise a second non-linear resonant reflector incorporating the at least one second non-linear crystal. The backward reflectivity of the second non-linear resonant reflector, with respect to radiation incident upon it from the first cavity part of the second complex cavity, can be self-regulated by the presence of the at least one second non-linear crystal to be as close to the optimal value for out-coupling the circulating intracavity power at a second fundamental frequency within the first cavity part of the second complex cavity. In some embodiments, a second temperature control device can be used for controlling the temperature of the at least one first non-linear crystal of the first non-linear resonant reflector for tuning and stabilizing a phase-matching condition for frequency conversion. In some embodiments, a second piezo-electical transducer (PZT) with an appropriate controlling electronics can be used for fine tuning and stabilizing the optical path of the second non-linear resonant reflector at resonance conditions,

A method for generating UV radiation includes generating a first laser beam in a first complex optical cavity having a neodymium-doped active medium, the laser beam at a second harmonic of the first fundamental frequency of the first complex optical cavity, pumping a ruby based active laser medium in a second complex laser cavity with an output from a first complex laser cavity, and producing a second laser beam in a second complex optical cavity having a ruby based active medium, the second laser beam at a second harmonic of the second fundamental frequency of the second complex optical cavity.

In some embodiments, a ruby based active medium can be Cr:Al₂O₃ type ruby The second laser beam can be about 347 nm. In some embodiments, the method can further include pumping the neodymium-doped active medium of the first complex optical cavity with a laser diode or a fiber coupled diode laser.

In some embodiments, the method can further include Q-switching the first laser beam at the first fundamental frequency in the first complex optical cavity. In some embodiments, the method can further include Q-switching the second laser beam at the second fundamental frequency in the second complex optical cavity.

In some embodiments, the method can further include implementation of at least one spectral selector for narrowing the emission spectrum at the first fundamental frequency. In some embodiments, the method can further include implementation of at least one spectral selector for narrowing the emission spectrum at the second fundamental frequency.

In the above laser system and method for generating UV emission at around 350 nm provides an advantage that the spectrum of the first laser beam that comes out from the first complex laser cavity at second harmonics of the first fundamental frequency is well overlapped with “green” absorption band of the ruby active laser medium, thus providing for a high gain inside the second complex laser cavity.

Still a further advantage of the above laser system and method is provided through the implementation of SHG as more efficient non-linear processes at both stages of frequency conversion, just completely eliminating the use of a lower efficiency non-linear process of THG.

### DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments,

FIG. 1 shows a known laser cavity layout commonly used for intracavity third harmonic generation (THG);

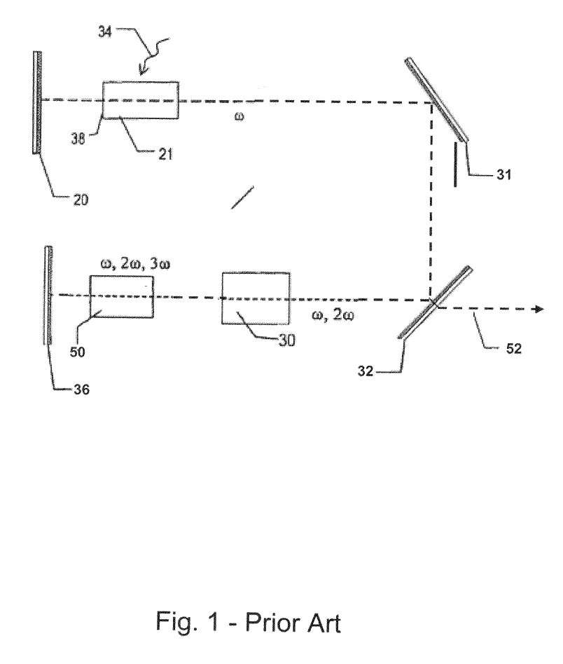

FIG. 2 shows a laser cavity configuration suitable for double enhanced intracavity frequency doubling of emission of a ruby laser pumped by the output of a double enhanced intracavity frequency doubled neodymium based laser; and

FIG. 3(a) and 3(b) show the power enhancement of each second cavity part with respect to its corresponding first cavity part and the actual backward reflectivity as a whole with respect to the first cavity part, respectively.

### DETAILED DESCRIPTION

Generally, the system and method described herein utilize the advantageous features of using a neodymium-doped active laser medium of a first complex laser cavity to pump a ruby based active medium of a second complex laser cavity to produce a laser beam at about 350 nm.

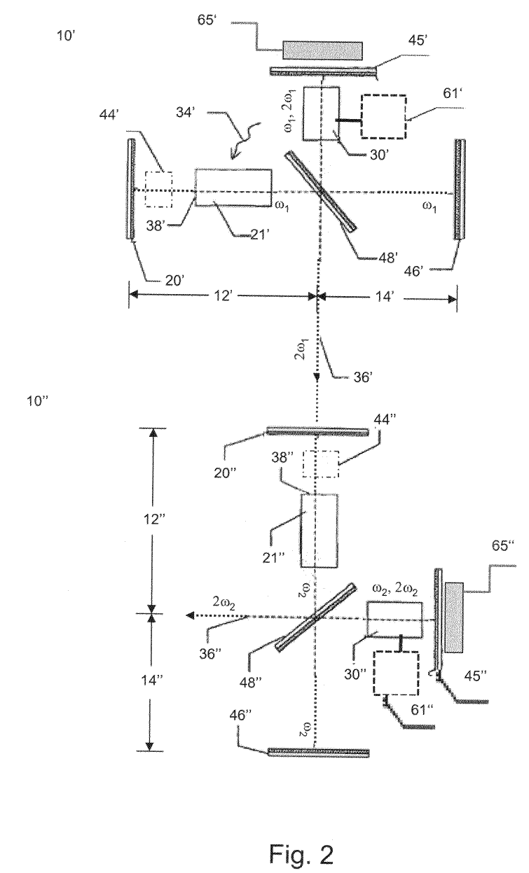

FIG. 2 shows an embodiment of a laser system including a first complex laser cavity 10′ output 36′ from which is used to pump an active laser medium 21″ in a second complex laser cavity 10″ to produce a laser beam 36″ at about 350 nm. The first complex laser cavity 10′ includes a first cavity part 12′ of lower level circulating first fundamental frequency (ω₁) power and a second cavity part 14′ of higher level circulating first fundamental frequency power (ω₁). The first cavity part 12′ includes a cavity back mirror 20′, and a neodymium-doped active medium 21′, and a beam splitter mirror 48′. The second cavity part 14′ includes the beam splitter mirror 48′, a non-linear crystal 30′, and two cavity end mirrors (45′, 46′). The waved arrow 34′ in the drawing indicates that an appropriate pump source of the active medium 21′ can be arranged either transversely and/or longitudinally.

In some embodiments, the cavity back mirror 20′ can be of high reflectivity at a first fundamental frequency (ω₁). In some embodiments, the cavity back mirror 20′ can be highly transmissive at the wavelength of a pump source for longitudinal pumping. In some embodiments, the cavity back mirror 20′ can be deposited onto the rear surface 38′ of the active medium 21′. The first cavity part 12′ can include an optional cavity loss modulator for Q-switching and/or spectral selector(s) for narrowing the emission spectrum at a first fundamental frequency (ω₁), in FIG. 2 these are shown under mark 44′. In some embodiments, the pump source can be a diode laser(s) or fiber coupled diode laser(s).

As shown in FIG. 2, the second cavity part 14′ of the complex cavity 10′ makes up the first non-linear resonant reflector and includes the two cavity end mirrors (45′, 46′), each of which is highly reflective at the a first fundamental frequency (ω₁), the beamsplitter mirror 48′ being partially reflective at the first fundamental frequency (ω₁), and the non-linear crystal 30′ of an appropriate cut and orientation to provide a phase matching condition for frequency doubling to produce an output 36′ at the second harmonic (2ω₁) of the first fundamental frequency (ω₁). In some embodiments, a first temperature control device 61′ for controlling the temperature of the non-linear crystal 30′ can be further provided for tuning and stabilizing a phase-matching condition for frequency conversion. In some embodiments, the mirror 45′ of the second cavity part 14′ of the first complex cavity 10′ can be placed on a first piezo-electrical transducer (PZT) 65′ with an appropriate electronics circuitry for fine tuning and stabilizing the first non-linear resonant reflector optical path at resonance conditions. To achieve the highest efficiency of the laser in the first complex optical cavity 10′, the reflectivity of the mirrors (20′, 45′, 46′) should be made as close to 100% as technologically possible at the required first fundamental frequency (ω₁). The appropriate partial reflectivity value of the beamsplitter mirror 48′ can be any value lying within some range around the reflectivity that would provide the backward reflectivity of the non-linear resonant reflector 14′ to be as close as for an optimal output coupler, if such a coupler were to be used (instead of the non-linear resonant reflector) simply to extract maximum power from the laser at the fundamental frequency (ω₁). The skilled person is familiar with the criteria for establishing the optimal reflectivity for such an arrangement.

With reference to FIG. 2, the complex cavity layout 10′ with the non-linear resonant reflector 14′ is shown, by way of example only, with the non-linear crystal placed between the mirrors 48′ and 45′, that is, angled to the optical axis of the first part 12′ of the cavity 10′. The nonlinear crystal 30′ can be also placed in the path between mirrors 46′ and 48′. There is no specific restriction on choosing the angle (for example 90°) of folding the first non-linear resonant reflector part of the complex laser cavity 10′ with respect to the optical axis of the first cavity part 12′, (and accordingly, the angle of tilting the beamsplitter mirror 48′) except those dictated by convenience of design and alignment.

As shown in FIG. 2, the second complex optical cavity 10″ includes a first cavity part 12″ of lower level circulating second fundamental frequency (ω₂) power and a second cavity part 14″ of higher level circulating second fundamental frequency power (ω₂). The first cavity part 12″ includes a cavity back mirror 20″, a ruby based active medium 21″, and a beam splitter mirror 48″. The second cavity part 14″ includes the beam splitter mirror 48″, a non-linear crystal 30″, and two cavity end mirrors (45″, 46″).

In some embodiments, the cavity back mirror 20″ can be of high reflectivity at a second fundamental frequency (ω₂). In some embodiments, the cavity back mirror 20″ can be highly transmissive at the second harmonic frequency (2ω₁) of the first fundamental frequency (ω₁) for longitudinal pumping In some embodiments, the cavity back mirror 20″ can be deposited onto the rear surface 38″ of the ruby based active medium 21″. In some embodiments, the first cavity part 12″ of the second complex cavity can include an optional cavity loss modulator for Q-switching and/or spectral selector(s) for narrowing the emission spectrum at a second fundamental frequency (ω₂), in FIG. 2 these are shown under mark 44″. In some embodiments, the ruby based active medium 21′ can be Cr:Al₂O₃ or the like.

As shown in FIG. 2, the second cavity part 14″ of the complex cavity 10″ makes up the second non-linear resonant reflector and includes the two cavity end mirrors (45″, 46″), each of which is highly reflective at the a second fundamental frequency (ω₂), the beamsplitter mirror 48″ being partially reflective at the second fundamental frequency (ω₂), and the non-linear crystal 30″ of an appropriate cut and orientation to provide a phase matching condition for frequency doubling to produce an output 36″ at around 350 nm. In some embodiments, a second temperature control device 61″ for controlling the temperature of the non-linear crystal 30″ can be further provided for tuning and stabilizing phase-matching condition for frequency conversion. In some embodiments, the mirror 45″ of the second cavity part 14″ of the second complex cavity 10″ can be placed on a second piezo-electrical transducer (PZT) 65″ with an appropriate electronics circuitry for fine tuning and stabilizing the second non-linear resonant reflector optical path at resonance conditions.

To achieve the highest efficiency of the laser in the second complex optical cavity 10″, the reflectivity of the mirrors (20″, 45″, 46″) should be made as close to 100% as technologically possible at the required second fundamental frequency (ω₂). The appropriate partial reflectivity value of the beamsplitter mirror 48″ can be any value lying within some range around the reflectivity that would provide the backward reflectivity of the non-linear resonant reflector 14″ to be as close as for an optimal output coupler, if such a coupler were to be used (instead of the non-linear resonant reflector) simply to extract maximum power from the laser at the second fundamental frequency (ω₂). The skilled person is familiar with the criteria for establishing the optimal reflectivity for such an arrangement.

In FIG. 2, the second complex cavity layout 10″ with the non-linear resonant reflector 14″ is shown, by way of example only, with the non-linear crystal placed between the mirrors 48″ and 45″, that is, angled to the optical axis of the first part 12″ of the cavity 10″. The nonlinear crystal 30″ can be also placed in the path between mirrors 46″ and 48″. There is no specific restriction on choosing the angle (for example 90°) of folding the second non-linear resonant reflector part of the complex laser cavity 10″ with respect to the optical axis of the first cavity part 12″, (and accordingly, the angle of tilting the beamsplitter mirror 48″) except those dictated by convenience of design and alignment.

In operation, the output 36′ at the second harmonic (2ω₁) of the first fundamental frequency (ω₁) from the first complex optical cavity 10′ longitudinally pumps the ruby based active medium 21″. The second harmonic frequency (2ω₁) between about 527 nm and about 532 nm for neodymium based active laser media overlaps well with the “green” absorption band of ruby (Cr:A₂O₃). In some embodiments, the output 36′ can be directed to the ruby based active medium 21″ by one or more steering mirrors (not shown), each of which is highly reflecting at the second harmonic (2ω₁) of the first fundamental frequency (ω₁). Additionally, focusing components (not shown) can be used to match the size of the pump beam 36′ with the size of fundamental transverse mode of the second complex laser cavity at the second fundamental frequency (ω₂) inside the ruby based active medium 21″. These focusing components can be mirrors with appropriate curvatures used to direct the output 36′ to the gain medium 21″ and/or appropriate lenses.

With reference to FIG, 2, for each of the complex optical cavities 10′ and 10″, the first cavity part (12′, 12″) enclosed between mirror (20′, 20″) and mirror (48′, 48″) holds a lower level of the intracavity circulating power, while the fundamental frequency power injected through the mirror (48′, 48″) and coupled in the second cavity part between mirror (45′, 45″), beamsplitter mirror (48′, 48″) and mirror (46′, 46″) is of a higher level because of resonance enhancement. At the resonance condition, the second cavity part (12′, 12″) acts as a nonlinear resonant reflector with respect to the first cavity part (10′, 10″). The level of the power enhancement (Enh) in the second cavity part (12′, 12″) and its actual backward reflectivity (Rback) as of a whole with respect to the first cavity part (10′, 10″) are dependent on balance of reflectivity of partially reflective beam splitter mirror (48′, 48″) and losses inside the second cavity part including loss (depletion) of fundamental frequency power resulting from the frequency conversion process inside the nonlinear crystal.

The above described power enhancement factor Enh and backward reflectivity Rback of the second cavity part are given by the following equations:

$$\begin{matrix}Enh ( ω ) = \frac{2 \cdot ( 1 - Rc ) \cdot R 1}{{( 1 - \sqrt{R 1 \cdot R 2} \cdot Rc \cdot T )}^{2}} \cdot \frac{1}{1 + \frac{4 ( \sqrt{R 1 \cdot R 2} \cdot Rc \cdot T )}{{( 1 - \sqrt{R 1 \cdot R 2} \cdot Rc )}^{2}} \cdot {( sin [ 2 \cdot π \cdot ω \cdot ( \frac{L 1 + L 2}{c} ) ] )}^{2}} & ( 1 ) \\ Rback ( ω ) = \frac{{( 1 - Rc )}^{2} \cdot R 1}{{( 1 - \sqrt{R 1 \cdot R 2} \cdot Rc \cdot T )}^{2}} \cdot \frac{1}{1 + \frac{4 ( \sqrt{R 1 \cdot R 2} \cdot Rc \cdot T )}{{( 1 - \sqrt{R 1 \cdot R 2} \cdot Rc )}^{2}} \cdot {( sin [ 2 \cdot π \cdot ω \cdot ( \frac{L 1 + L 2}{c} ) ] )}^{2}} , & ( 2 )\end{matrix}$$

where R1 and R2 stand for the reflectivity at frequency ω of mirrors 46 and 45 respectively, Rc is the reflectivity at frequency ω of the partially reflective beamsplitter mirror (48′, 48″), L1 and L2 are optical paths at frequency ω between mirrors 48 and 46; and 48 and 45, respectively, and T is the non-linear crystal transmission at frequency ω taking into account its all losses including the loss resulting from the nonlinear frequency conversion process. In practice, R1·R2≅1 (about 0.9998) and the transmission T is in a range between about 0.95 and 0.995.

From the above equations, the power enhancement factor Enh(ω) and backward reflectivity Rback(ω) are periodic functions of frequency having their maxima at frequencies which make

$$ω \cdot ( ( L 1 + L 2 ) / c )$$

an integer. This is the resonance condition. The corresponding maxima values for equations (1) and (2), respectively, are.

$$\begin{matrix}EnhMax ( Rc ) = \frac{2 \cdot ( 1 - Rc ) \cdot R 1}{{( 1 - \sqrt{R 1 \cdot R 2} \cdot Rc \cdot T )}^{2}} & ( 3 ) \\ RbackMax ( Rc ) = \frac{{( 1 - Rc )}^{2} \cdot R 1}{{( 1 - \sqrt{R 1 \cdot R 2} \cdot RcT )}^{2}} & ( 4 )\end{matrix}$$

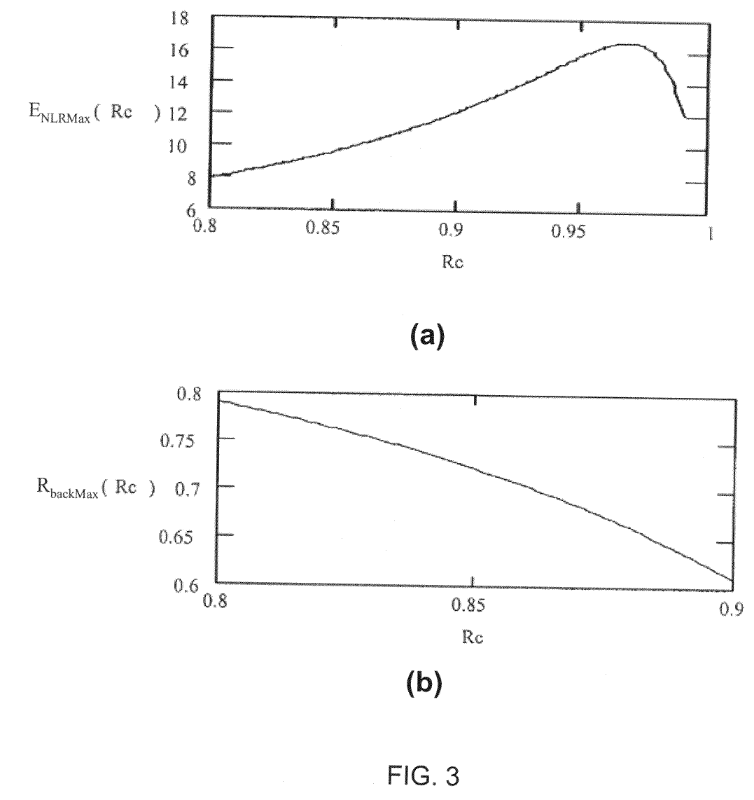

FIGS. 3(a) and 3(b) illustrate, respectively, the dependence of EnhMax and RbackMax on the partial reflectivity value of the beamsplitter mirror (48′, 48″) at the transmission T=0.99 As it is seen from FIG. 3(a) for this case of T, the value of the fundamental frequency power in the second cavity part (14′, 14″) can be as higher than that in the first cavity part (12′, 12″) by an amount in the range of 10-16 times.

With the above reflectivities of the laser cavity mirrors the fundamental frequency power circulating inside each of the complex optical cavities (10′, 10″) (FIG. 2) has two different levels: a lower level within the cavity path between the cavity back mirror (20′, 20″) and beamsplitter mirror (48′, 48″), and a higher level within the non-linear resonant reflector path between the mirror (46′, 46″), mirror (48′, 48″) and mirror (45′, 45″). The lower level, however, is already an enhanced level of the fundamental frequency power as compared with what it would be outside the laser cavity.

Thus, for the non-linear crystal being placed within the non-linear resonant reflector part of the complex laser cavity there are two stages of enhancement of the fundamental frequency power. Due to the optical non-linearity being incorporated within the resonant reflector, the backward reflectivity (in the direction of the cavity back mirror (20′, 20″) is self regulated to be close to the optimal value for out-coupling the fundamental frequency power that is circulating within first part of the complex optical cavity (10′, 10″). This provides the condition for the maximum second harmonic output (36′, 36″) with respect to the pump power supplied to the active medium (21′, 21″) and hence the optimum laser efficiency, and provides minimal sensitivity of the laser output to the laser cavity loss variations due to external disturbances and limited spec tolerances of the laser cavity components.

To arrange for the output of the second harmonic power from the complex laser cavity in desired direction, the reflectivities of the mirror (45′, 45″), beamsplitter mirror (48′, 48″) and mirror (46′, 46″) at the second harmonic frequency (2ω₁, 2ω₂) must be chosen appropriately. In the case as shown in FIG. 2, for example, mirror (45′, 45″) is also highly reflective at the second harmonic frequency (2ω₁, 2ω₂) and the beamsplitter mirror (48′, 48″) is highly transmissive at second harmonic frequency (2ω₁, 2ω₂). Hence, the second harmonic output power is directed as shown by path (36′, 36″). Alternatively, for the second harmonic power to be output through the mirror (46′, 46″), the latter should be highly transmissive at the second harmonic frequency (2ω₁, 2ω₂), while both the mirror (45′, 45″) and the beamsplitter mirror (48′, 48″) should be highly reflective at the second harmonic frequency (2ω₁, 2ω₂). In the case of the first complex optical cavity 10′, the second harmonic power output through mirror 46′ would have to be directed to the active medium 21′ for pumping.

While optical layouts and processes have been described and illustrated with reference to particular embodiments thereof, those skilled in the art will appreciate that various adaptations, changes, modifications or additions can be made without departing from the spirit of the invention. The system and methods described herein can be incorporated into known laser systems.

What is claimed is:

1. A laser system, comprising:
a first complex optical cavity, including:
a first cavity part of a lower level circulating first fundamental frequency power of the first complex optical cavity and a second cavity part of higher level circulating first fundamental frequency power of the first complex optical cavity;
a neodymium-doped active medium in the first cavity part of the first complex optical cavity;
at least one first non-linear crystal in the second cavity part of the first complex optical cavity;
a second complex optical cavity, including:
a first cavity part of a lower level circulating second fundamental frequency power of the second complex optical cavity and a second cavity part of higher level circulating second fundamental frequency power of the second complex optical cavity;
a ruby based active medium in the first cavity part of the second complex optical cavity;
at least one second non-linear crystal in the second cavity part of the second complex optical cavity; and
wherein an output beam from the first complex optical cavity at a second harmonic of the first fundamental frequency pumps the ruby based active medium of the second complex optical cavity.

2. The laser system of claim 1, wherein the ruby based an active medium is Cr:Al₂O₃ type ruby.

3. The laser system of claim 1, wherein an output of the second complex optical cavity is configured to be at the second harmonic of the second fundamental frequency.

4. The laser system of claim 3, wherein the output of the second complex optical cavity is about 347 nm.

5. The laser system of claim 1, wherein the first cavity part of the first complex optical cavity includes a cavity loss modulator for Q-switching.

6. The laser system of claim 1, wherein the first cavity part of the first complex optical cavity includes at least one spectral selector for narrowing an emission spectrum at the first fundamental frequency.

7. The laser system of claim 1, wherein the first cavity part of the second complex optical cavity further includes a cavity loss modulator for Q-switching.

8. The laser system of claim 1, wherein the first cavity part of the second complex optical cavity includes at least one spectral selector for narrowing an emission spectrum at the second fundamental frequency.

9. The laser system of claim 1, wherein the neodymium-doped active medium of the first complex optical cavity is pumped by a diode laser or a fiber coupled diode laser.

10. The laser system of claim 1, wherein the neodymium-doped active medium is neodymium-doped yttrium vanadate (Nd:YVO₄), neodymium-doped yttrium aluminum garnet (Nd:YAG), or neodymium-doped yttrium lithium fluoride (Nd:YLF).

11. The laser system of claim 1, wherein the second part of the first complex cavity comprises a first non-linear resonant reflector incorporating the at least one first non-linear crystal.

12. The laser system of claim 11, wherein the backward reflectivity of the first non-linear resonant reflector, with respect to radiation incident upon it from the first cavity part of the first complex cavity, is self-regulated by the presence of the at least one first non-linear crystal to be as close to the optimal value for out-coupling the circulating intracavity power at a first fundamental frequency within the first cavity part.

13. The laser system of claim 1, further comprising a first temperature control device for controlling the temperature of the at least one first non-linear crystal of the first non-linear resonant reflector for tuning and stabilizing a phase-matching condition for frequency conversion.

14. The laser system of claim 1, further comprising a first piezo-electric circuitry control device for fine tuning and stabilizing a first non-linear resonant reflector optical path at resonance conditions,

15. The laser system of claim 1, wherein the second cavity part of the second complex cavity comprises a second non-linear resonant reflector incorporating the at least one second non-linear crystal.

16. The laser system of claim 14, wherein the backward reflectivity of the second non-linear resonant reflector, with respect to radiation incident upon it from the first cavity part of the second complex cavity, is self-regulated by the presence of the at least one second non-linear crystal to be as close to the optimal value for out-coupling the circulating intracavity power at a second fundamental frequency within the first cavity part.

17. The laser system of claim 1, further comprising a second temperature control device for controlling the temperature of the at least one second non-linear crystal of the second non-linear resonant reflector for tuning and stabilizing a phase-matching condition for frequency conversion.

18. The laser system of claim 1, further comprising a second piezoelectric circuitry control device for fine tuning and stabilizing a second non-linear resonant reflector optical path at resonance conditions.

19. A method for generating UV radiation by pumping an active laser medium of second complex laser cavity with an output from a first complex laser cavity, comprising:
generating a first laser beam in a first complex optical cavity having a neodymium-doped active medium, the laser beam at a second harmonic of the first fundamental frequency of the first complex optical cavity;
pumping a ruby based active laser medium in a second complex laser cavity with an output from a first complex laser cavity; and
producing a second laser beam in a second complex optical cavity having a ruby based active medium, the second laser beam at a second harmonic of the second fundamental frequency of the second complex optical cavity.

20. The method of claim 19, wherein the ruby based an active medium is Cr:Al₂O₃ type ruby.

21. The method of claim 19, wherein the second laser beam is about 347 nm.

22. The method of claim 19, further comprising Q-switching the first laser beam at the first fundamental frequency in the first complex optical cavity.

23. The method of claim 19, further comprising Q-switching the second laser beam at the second fundamental frequency in the second complex optical cavity.

24. The method of claim 19, further comprising spectrum narrowing of the first laser beam at the first fundamental frequency in the first complex optical cavity.

25. The method of claim 19, further comprising spectrum narrowing of the second laser beam at the second fundamental frequency in the second complex optical cavity.

26. The method of claim 19, further comprising pumping the neodymium-doped active medium of the first complex optical cavity with a laser diode or a fiber coupled laser diode.

27. A method for generation of UV radiation by pumping an active laser medium in a second complex laser cavity with an output from a first complex laser cavity, comprising:
means for generating a first laser beam in a first complex optical cavity having a neodymium-doped active medium, the laser beam at a second harmonic of the first fundamental frequency of the first complex optical cavity; and
means for producing a second laser beam in a second complex optical cavity having a ruby based active medium, the second laser beam at a second harmonic of the second fundamental frequency of the second complex optical cavity.
